(19) United States
(12) Patent Application Publication
(10) Pub. No.: US 2003/0077108 A1
(43) Pub. Date: Apr. 24, 2003

(54) Loose leaf folder

(76) Inventor: Shlomo Menahem, Hadera (IL)

Correspondence Address: ROBERT L STONE PC, 13 MEADOWLARK LN, EAST BRUNSWICK, NJ, 08816, US

(21) Appl. No.: 10/277,166

(22) Filed: Oct. 18, 2002

(30) Foreign Application Priority Data
Oct. 18, 2001 (IL) 146060

(51) Int. Cl. B42F 3/00; B42F 13/02

(52) U.S. Cl. 402/8

(57) ABSTRACT

A folder for holding loose leaf pages including a cover member and two elongated, semi-rigid, elastic leaf-engaging tongues coupled to the cover member, wherein the length of the tongues is at least three quarters the width of a loose-leaf page, and further including at least one substantially rigid hanging element reciprocatably coupled to the cover member, each hanging element including a tongue-receiving aperture, wherein the tongue-receiving aperture in at least one of the hanging elements merges into an elongate slit, in which a threaded tongue can be lockingly engaged.

### FIELD OF THE INVENTION

The present invention relates to loose leaf folders in general and, more particularly, to closure elements for retaining loose pages in a file folder or binder.

### BACKGROUND OF THE INVENTION

Loose leaf files and folders of various kinds have long been known in the art. These generally include a front and back cover with a fastener mounted therein. One common style of fastener includes two elongate tongues, arranged to extend through a pair of holes punched in the pages, and a plastic or metal locking element, which slides onto or around the tongues and secures them against movement.

These tongues typically consist of thin plastic tubes or strips, such as shown in UK patent 927,513, a tightly wound metal coil, such as shown in UK patent 1,200,592, or thin, flat strips, such as seen in U.S. Pat. No. 2,289,949. These tongues are threaded through holes punched in the pages to be filed, and then must be threaded through the locking element, or the locking element is inserted around them, thereby locking the tongues against movement.

Fastening and unfastening these fastening members is a time consuming process. Furthermore, when the tongues are locked in place by the locking elements, the folder cannot be opened flat in order to read the innermost margin of the page, or to photocopy a page in the middle of the folder. Rather, the fastener must be opened, all the pages on top of the desired page must be removed, and only then can the desired page be removed, copied, and returned to its place.

Proposed solutions to this problem include ring binders and the loose-leaf binder which includes a fastener which consists of two opposed rigid tubes, one arranged to slide telescopically into the other. Before opening the binder, the pages are moved onto one or the other of the tubes, then the fastener is opened and the page can be removed. These binders are awkward to operate and are not suitable for a relatively flat file folder.

Applicant's Israeli patent number 115802 describes, inter alia, a hanging folder for loose leaf pages including a foldable cover member, four substantially rigid hanging elements coupled to the cover member, and at least two elongated, semi-rigid, elastic leaf-engaging tongues, each threaded through the cover member and two of the hanging members, the length of the tongues being at least three quarters the width of a page. The hanging elements in this patent define a slot or aperture through which the tongues can be threaded.

However, when hanging such folders in a hanging file, it is preferable to be able to lock at least one of the fasteners in a selected position, to prevent the pages thereon from falling out.

Accordingly, there is a long felt need for a fastener which securely retains loose pages in a folder or binder but which can be locked in a particular orientation to prevent release of pages from the fastener.

### SUMMARY OF THE INVENTION

According to the present invention, there is provided a folder for holding loose leaf pages including a cover member and two elongated, semi-rigid, elastic leaf-engaging tongues coupled to the cover member, wherein the length of the tongues is at least three quarters the width of a loose-leaf page, and further including at least one substantially rigid hanging element reciprocatably coupled to the cover member, each hanging element including a tongue-receiving aperture, wherein the tongue-receiving aperture in at least one of the hanging elements merges into an elongate slit, in which a threaded tongue can be lockingly engaged.

According to one embodiment of the invention, the tongue-receiving aperture merges into an elongate slit on both ends thereof

Still further according to the present invention, there is provided a substantially rigid hanging element for use with a folder, the hanging element defining a tab at one end thereof, and a tongue-receiving aperture, merging into an elongate slit, in which a threaded tongue can be lockingly engaged

According to one embodiment, an elongate slit extends on both ends of the tongue-receiving aperture.

There is also provided, according to the invention, a method for filing punched loose leaf pages in a folder including a back cover and a front cover, the method including coupling two elongated semi-rigid elastic leaf-engaging tongues to the back cover, the length of the tongues being at least three quarters the width of a loose leaf page, threading the tongues through the punched loose-leaf pages, providing a folded engagement portion in the front cover through which the tongues are threaded, and locking the tongues in place by frictional engagement with the folded engagement portion, the improvement including reciprocatably coupling at least one substantially rigid hanging element to the cover, each hanging element defining a tab at one end thereof, and a tongue-receiving aperture merging into an elongate slit, threading each tongue through the tongue-receiving aperture in a hanging element, and locking the tongue in the hanging element by engaging the tongue in the elongate slit.

Still further according to the present invention, at least one of said hanging elements includes two tongue-receiving apertures, each tongue-receiving aperture merging into an elongate slit in which a threaded tongue can be lockingly engaged.

### BRIEF DESCRIPTION OF THE DRAWINGS

The present invention will be further understood and appreciated from the following detailed description taken in conjunction with the drawings in which:

FIG. 1 is a perspective view of a folder constructed and operative in accordance with one embodiment of the invention;

FIG. 2a is a perspective view of a hanging element of the folder of FIG. 1, constructed and operative in accordance with one embodiment of the present invention;

FIG. 2b is a perspective view of the hanging element of FIG. 2a, in a locked orientation;

FIG. 3 is a perspective view of a hanging element constructed and operative in accordance with another embodiment of the present invention;

FIG. 4 is a plan view of a hanging element constructed and operative in accordance with still another embodiment of the present invention;

FIG. 5a is a perspective view of a folder constructed and operative in accordance with a further embodiment of the invention; and

FIG. 5b is a plan view of one embodiment of the hanging element of the folder of FIG. 5a in an open orientation; and

FIG. 5c is a plan view of one embodiment of the hanging element of the folder of FIG. 5a in a closed orientation

### DETAILED DESCRIPTION OF THE INVENTION

The present invention relates to file folders which do not require a separate locking or retaining element to hold the tongues, which retain loose leaf pages in place. This is achieved by providing leaf-engaging tongues which are semi-rigid but elastic and whose length is at least three quarters the width of a page to be filed in the folder. Preferably, the length of the tongues is the same as the width of a page, or any other length which prevents the tongues from disengaging from the folder or the pages therein during reading or separation of the pages. In particular, the folder includes at least one, and up to four reciprocating hanging elements, at least one of which defines a tongue-receiving aperture merging into an elongate slit. A tongue of the folder is threaded through the tongue-receiving aperture in the hanging element, and can be retained in any desired position by frictional engagement of the tongue in the elongate slit.

While the hanging elements in the parent application, Israel Patent number 115802, were utilized for hanging the folders in hanging files, the hanging elements in the present invention may serve either or both of two purposes. First, they are useful for hanging files in hanging folders, as in the parent application. Second, they are useful for easily, rapidly, and automatically locking the tongues in a particular desired position, so as to prevent the filed pages from inadvertently falling out of the folder. Thus, the present invention is useful both for folders in hanging files, wherein extending the hanging elements from the cover causes the tongues to automatically be locked in position, and in folders in standing files, wherein pushing the “hanging” elements into the cover cause the tongues to automatically be locked in position.

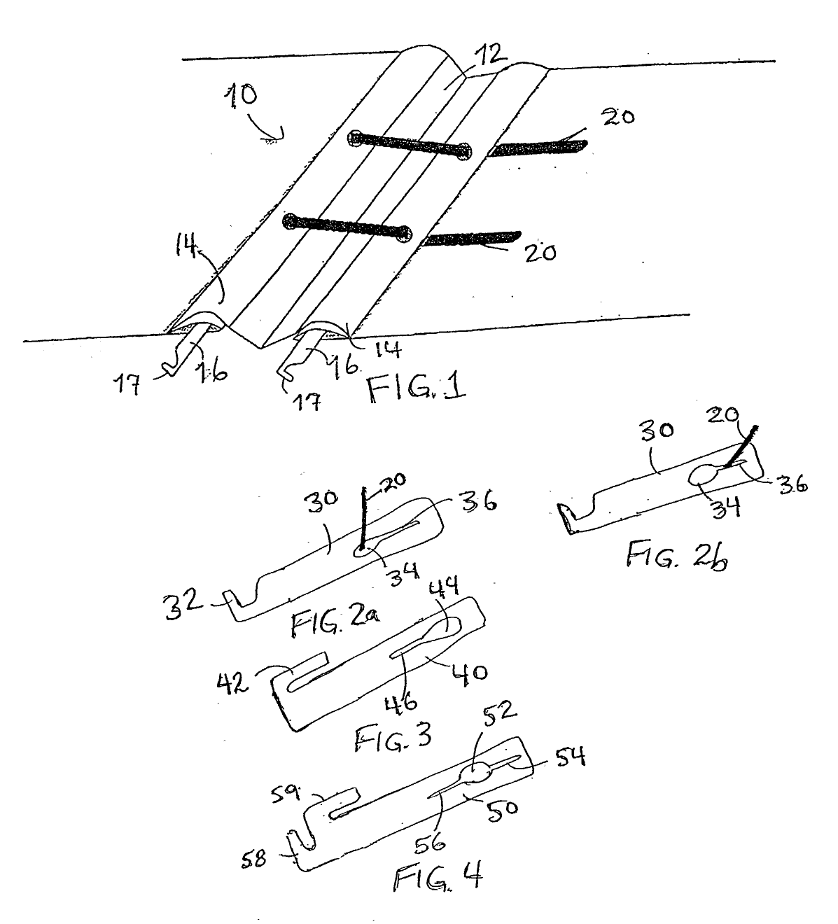

It will be appreciated that pages generally are removed from a file folder in order to copy them. It is a particular feature of the present invention that loose leaf pages are retained in the folder in a secure fashion without fear of falling out, yet the file can be opened and the pages separated to a substantially fiat orientation which permits photocopying of any page in the folder. In addition, when it is desired to “lock” the pages in place, it is merely necessary to slide the hanging elements to an orientation for engaging the tongue, as described below Referring now to FIG. 1, there is shown a file folder 10 constructed and operative in accordance of the present invention. Folder 10 is a hanging folder, which includes a foldable cover member 12 defining two folds 14 for engaging two or four hanging elements 16. (At least one hanging element is required on each end of the file, in order to provide symmetry of hanging.) Preferably, the edges of folds 14 are glued to cover member 12, so as to prevent hanging elements 16 from falling out. Alternatively, the hanging elements can be mounted inside fold 14, itself. Each hanging element 16 is a substantially rigid element including a hook tab 17 and tongue-receiving aperture (not shown). Two tongues 20, here shown as flat strips, are threaded through cover member 12 and through the tongue-receiving apertures in hanging elements 16.

Tongues 20 can be coupled to cover 12 in any fashion, such as threading through holes in the cover 12, stapling or affixing in any other known manner. It will be appreciated that, alternatively, tongues 20 can be the two ends of a single element threaded through cover 12.

Tongues 20 are formed of a semi-rigid but elastic material, such as semi-rigid plastic or metal, including, but not limited to, flexible polypropylene and steel. This is to permit the tongues 20 to bend without folding and to return to their original shape when not under pressure. Tongues 20 may have any desired shape, including a substantially flat strip, a tube, a hemisphere cross-section, a tightly wound metal coil or spiral spring or any other shape which permits easy threading of the tongues through the holes in loose leaves to be filed, while providing ease of locking. Pulling a tongue 20 outwardly tightens the pages.

According to the present invention, the tongue-receiving aperture in the hanging element merges into at least one elongate slit, narrower at the closed end than at the aperture, so as to engage, by friction, the tongue, which is preferably slightly thicker. Preferably the tongue-receiving aperture merges into two slits, one on each end of the aperture. With reference to FIG. 2a, there is shown a perspective view of a hanging element 30 of the folder of FIG. 1, constructed and operative in accordance with one embodiment of the present invention. Hanging element 30 is a substantially rigid element including a hook tab 32 and a tongue-receiving aperture 34. Tongue-receiving aperture 34 merges into an elongate slit 36, towards the center of the folder, in such a way as to be able to engage a tongue threaded through the hanging element and prevent further sliding movement of the tongue, as shown in FIG. 2b.

The hanging element of FIG. 2a is particularly useful for hanging a hanging file and locking the tongues, and therefore preventing inadvertent release of loose leaf pages, when the folder is hanging upside down in a hanging file. Thus, upon extending the hanging elements from the cover in order to hang the file, Thus, upon are automatically engaged by the slit in the hanging elements. It will be appreciated that sliding the hanging elements backs into the cover member, when the folder is removed from the hanging file, will release the tongues and pages as needed for perusal or photocopying of pages in the folder.

Referring now to FIG. 3, there is shown a plan view of a hanging element 40, constructed and operative in accordance with another embodiment of the present invention. As can be seen, hanging element 40 includes a pull-tab 42 at one end thereof, and a tongue-receiving aperture 44. In this embodiment, tongue-receiving aperture 44 merges into a slit 46 in the direction of the pull-tab 42 on the hanging element. This embodiment is suitable for use in folders in standing files, wherein slight insertion of the hanging elements (which, this embodiment, do not serve to “hang” anything) into the cover serves to lock the tongue in slit 46, and wherein a slight extension of the hanging elements releases the tongues from the slit for ease of opening the file and photocopying pages.

Alternatively, the hanging element 40 of this embodiment can be incorporated into a conventional hanging file of other file folder, for the purpose of locking the tongue or tongues.

FIG. 4 is a plan view of a hanging element 50 constructed and operative in accordance with still another embodiment of the present invention. In this embodiment, the hanging element 50 includes a tongue-receiving aperture 52 which merges into two slits 54 and 56, one on either end of the tongue receiving aperture 52. Hanging element 50 also includes a hook tab 58 and a pull-tab 59, to permit extension and retraction of the hanging element from the file cover. In this way, a single design of hanging element can be used for folders in both hanging files and standing files.

It will be appreciated by those skilled in the art that, in the embodiment of FIG. 3 for use in standing files, it is possible to use a single hanging element. The hanging element can include either one or two tongue-engaging apertures. It is sufficient to engage and lock one of the tongues, so as to prevent opening of the file, and removal of pages. Engaging and locking both tongues provides increased security.

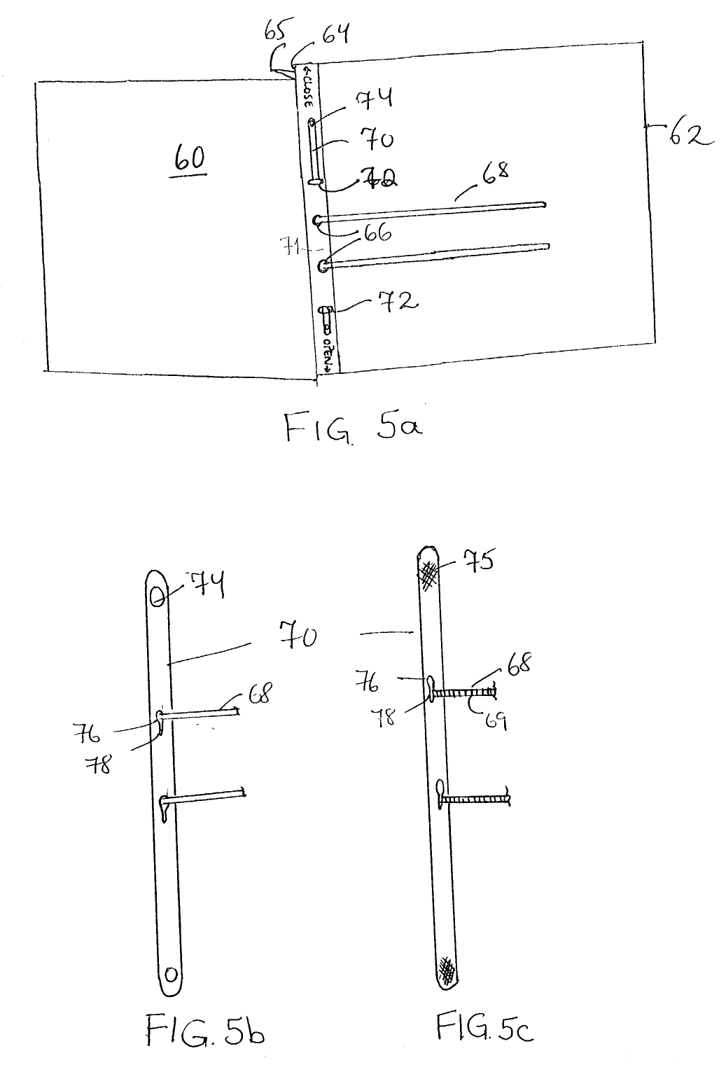

One embodiment of a hanging element with two tongue-receiving apertures is shown in FIGS. 5a, 5b and 5c. FIG. 5a shows a perspective view of a folder 60 constructed and operative in accordance with a further embodiment of the invention, and FIGS. 5b and 5c are partially cut away views, showing a plan view of the hanging element 70 therein in respective open and closed orientations. Folder 60 is a standing folder, including a foldable cover member 62 defining two folds 64, 65 for holding loose leaf pages therebetween. Apertures 66 are provided in folds 64 and 65 through which tongues 68 can be threaded.

Fold 64 also serves to engage hanging element 70, as in a sleeve 71 defined in fold 64 by two slits 72. Hanging element 70 is a substantially rigid element including two readily graspable end portions (illustrated in FIG. 5b as having a cut-out 74 for ease of grasping the edge of the element, although alternatively, any rough surface 75 to prevent slipping can be provided, instead, such as shown in FIG. 5c), and two tongue-receiving apertures 76. Tongue-receiving apertures 76 taper or merge into an elongate slit 78, narrower at the closed end than at the aperture. In the open orientation, shown in FIG. 5b, tongue-receiving apertures 76 are arranged to sit in register with apertures 66 in folds 64 and 65 in the folder. In the closed orientation, shown in FIG. 5c, hanging element 70 is moved relative to the folder 60 so that slits 78 in tongue receiving apertures 76 frictionally engage the sides of the tongues 68.

According to a preferred embodiment of the invention, tongues 68 are formed of a flexible plastic material, such as polypropylene or polyethylene, and include a plurality of ribs 69 extending across the width of the tongues. Ribs 69 improve engagement in the slits of hanging element 70 and increase stability.

It will be appreciated that locking in this fashion is not required in order to hold the file papers in the folder of the present invention. However, when the file is opened to the flat orientation for photocopying, the pages can be held in the desired orientation by locking the pages by means of the locking element. An optional additional aperture can be provided on the innermost side of the fold 64, or on the folded edge thereof, to permit ease of pushing or pulling the hanging element when the file is open flat.

It will be appreciated that the invention is not limited to what has been described hereinabove merely by way of example. Rather, the invention is limited solely by the claims which follow.

1. A folder for holding punched loose leaf pages including: a. a cover member; and b. two elongated, semi-rigid, elastic leaf-engaging tongues coupled to said cover member; wherein the length of said tongues is at least three quarters the width of a loose leaf page, and further comprising;
at least one substantially rigid hanging element reciprocatably coupled to the cover member;
each hanging element including a tongue-receiving aperture;
wherein the tongue-receiving aperture in at least one of the hanging elements merges into an elongate slit, in which a threaded tongue can be lockingly engaged.

2. The folder according to claim 1, wherein the tongue-receiving aperture merges into two elongate slits, one on each end thereof.

3. The folder according to claim 1, wherein at least one hanging element includes two tongue-receiving apertures, each tongue-receiving aperture merging into an elongate slit in which a threaded tongue can be lockingly engaged.

4. The folder according to claim 1, further comprising a sleeve defined in a fold in the cover member, said at least one hanging element being threaded through said sleeve.

5. The folder according to claim 1, including:
a. at least two substantially rigid hanging elements coupled to the cover member;
b. at least two elongated, semi-rigid, elastic, leaf-engaging tongues, each threaded through said cover member and one of said hanging members, the length of said tongues being at least three quarters the width of a loose leaf page;
wherein at least one of said hanging elements includes a tongue-receiving aperture; and
the tongue-receiving aperture in at least one of the hanging elements merges into at elongate slit, in which a threaded tongue can be lockingly engaged.

6. A folder according to claim 1, wherein said tongues include a flat strip.

7. The folder according to claim 5, wherein at least one of said hanging elements includes two tongue-receiving apertures, each tongue-receiving aperture merging into an elongate slit in which a threaded tongue can be lockingly engaged.

8. The folder according to claim 2, wherein at least one hanging element includes two tongue-receiving apertures, each tongue-receiving aperture merging into an elongate slit in which a threaded tongue can be lockingly engaged.

9. A substantially rigid hanging element for use with a folder with a tongue, the hanging element defining a tab at one end thereof, and comprising a tongue-receiving aperture, merging into an elongate slit, in which a threaded tongue can be lockingly engaged.

10. The hanging element according to claim 9, wherein said tongue-receiving aperture merges into two elongate slits, one on each end of the tongue-receiving aperture.

11. The hanging element according to claim 9, including two tongue-receiving apertures, each tongue-receiving aperture merging into an elongate slit in which a threaded tongue can be lockingly engaged.

12. The hanging element according to claim 10, including two tongue-receiving apertures, each tongue-receiving aperture merging into an elongate slit in which a threaded tongue can be lockingly engaged.

13. A method for forming a folder for filing punched loose leaf pages, the method comprising the steps of:
a. coupling two elongated semi-rigid elastic leaf-engaging tongues to a cover element, the length of said tongues being at least three quarters the width of a loose leaf page;
b. providing a folded engagement portion in said cover element through which said tongues are threaded for locking said tongues in place by frictional engagement with said folded engagement portion;
c. reciprocatably coupling at least one substantially rigid hanging element to the cover, at least one of said hanging elements defining a tongue-receiving aperture merging into an elongate slit; and
d. threading at least one tongue through the tongue-receiving aperture in a hanging element to permit locking of the tongue in the hanging element by engaging the tongue in the elongate slit.

14. The method according to claim 12, wherein at least one of said hanging elements includes two tongue-receiving apertures, each tongue-receiving aperture merging into an elongate slit in which a threaded tongue can be lockingly engaged, wherein said step of threading includes threading each tongue through the tongue-receiving aperture in a hanging element.
